(19) United States
(12) Patent Application Publication
(10) Pub. No.: US 2022/0417378 A1
(43) Pub. Date: Dec. 29, 2022

(54) AUTHENTICATION SYSTEM, INFORMATION PROCESSING APPARATUS, AND IMAGE FORMING APPARATUS

(71) Applicant: SHARP KABUSHIKI KAISHA, Sakai City (JP)

(72) Inventor: TSUYOSHI NAGAO, Sakai City (JP)

(21) Appl. No.: 17/849,127

(22) Filed: Jun. 24, 2022

(30) Foreign Application Priority Data
Jun. 29, 2021 (JP) 2021-108009

(51) Int. Cl. H04N 1/00; G06F 21/31; H04L 9/40

(52) U.S. Cl. CPC H04N 1/00854; G06F 21/31; H04L 63/0892

(57) ABSTRACT

An authentication system in which an image forming apparatus authenticates a user, the authentication system includes: an obtainer that obtains, from a terminal apparatus, a mail address of, and security information on, the user; a verificator that verifies the security information at a verification point identified with the mail address; and an authenticator that authenticates the user if the security information is able to be verified correctly.

### CROSS-REFERENCE TO RELATED APPLICATION

The present application claims priority from Japanese Patent Application Number 2021-108009, the content to which is hereby incorporated by reference into this application.

### BACKGROUND OF THE INVENTION

### 1. Field of the Invention

The present disclosure relates to such apparatuses as an information processing apparatus.

### 2. Description of the Related Art

Conventionally, image forming apparatuses such as multifunction peripherals and printers have been used to output images by xerography. Moreover, techniques to associate the image forming apparatuses with services provided through a network (e.g. Web services and cloud services) have also been proposed.

For example, a proposed technique links an access token to be obtained from a Web service server and information on an IC card to be used for authentication of a user using an image forming apparatus (see, for example, Japanese Unexamined Patent Application Publication No. 2016-126462).

Recently, techniques to operate image forming apparatuses using such terminals as smartphones have been widely used. Here, a technique described in Japanese Unexamined Patent Application Publication No. 2016-126462 needs such an apparatus as an IC card reader for reading an IC card. The technique does not consider a case where the image forming apparatus is used with the terminal apparatus alone.

Moreover, an apparatus such as the image forming apparatus receives security information such as an access token from an apparatus such as the terminal apparatus, so that the image forming apparatus can determine that the user using the terminal apparatus has been authenticated by an apparatus (e.g. a server apparatus) providing such services as a Web service. However, if the image forming apparatus manages privileges that users have, and stores information on a usage history for each of the users, the image forming apparatus needs a means to, for example, determine the user.

In view of the above problem, the present disclosure is intended to provide an authentication system and the like that authenticates a user when security information is successfully verified correctly.

### SUMMARY OF THE INVENTION

In order to solve the above problem, an authentication system according to the present disclosure allows an image forming apparatus to authenticate a user. The authentication system includes: an obtainer that obtains, from a terminal apparatus, a mail address of, and security information on, the user; a verificator that verifies the security information at a verification point identified with the mail address; and an authenticator that authenticates the user if the security information is able to be verified correctly.

An information processing apparatus according to the present disclosure includes: an obtainer that obtains a mail address of, and security information on, a user; a security information transmitter that transmits the security information to a server apparatus at a verification point corresponding to the mail address; a result receiver that receives a verification result from the server apparatus at the verification point; and a verification result transmitter that authenticates the user if the verification result is correct, and transmits an authentication result to an image forming apparatus.

An image forming apparatus according to the present disclosure includes: an obtainer that obtains, from a terminal apparatus, a mail address of, and security information on, a user; a transmitter that transmits the mail address and the security information to a first server apparatus at an authentication point; a receiver that receives an authentication result of the user, in accordance with a result of verifying the security information by a second server at a verification point at which the first server apparatus is identified with the mail address; and an authenticator that authenticates the user if the authentication is correct.

A control method according to the present disclosure is a method for controlling an authentication system in which an image forming apparatus authenticates a user. The control method includes: obtaining, from a terminal apparatus, a mail address of, and security information on, the user; verifying the security information at a verification point identified with the mail address; and authenticating the user if the security information is able to be verified correctly.

The present disclosure can provide an authentication system and the like to authenticate a user when security information is successfully verified correctly.

### BRIEF DESCRIPTION OF THE DRAWINGS

FIG. 1 is a diagram illustrating an overall configuration of a system according to a first embodiment;

FIG. 2 is a diagram illustrating a functional configuration of a terminal apparatus according to the first embodiment;

FIG. 3 is a diagram illustrating a functional configuration of an authentication server according to the first embodiment;

FIG. 4 is a table showing an exemplary data structure of user information managed on the authentication server according to the first embodiment;

FIG. 5 is a diagram illustrating a functional configuration of an image forming apparatus according to the first embodiment;

FIG. 6 is a table showing an exemplary data structure of session information according to the first embodiment;

FIG. 7 is a diagram illustrating a functional configuration of an IdP server according to the first embodiment;

FIG. 8 is a table showing an exemplary data structure of user information managed by the IdP server according to the first embodiment;

FIG. 9 is a sequence diagram showing a sequence of processing on the system according to the first embodiment;

FIG. 10 is a sequence diagram showing a sequence of privilege confirmation according to the first embodiment;

FIG. 11 is a flowchart showing a sequence of processing to be executed by the terminal apparatus according to the first embodiment;

FIG. 12 is a flowchart showing a sequence of processing to be executed by the terminal apparatus according to the first embodiment;

FIG. 13 is a flowchart showing a sequence of session ID issuing processing according to the first embodiment;

FIG. 14 is a flowchart showing a sequence of processing to be executed by the authentication server according to the first embodiment;

FIG. 15 is a flowchart showing a sequence of authentication processing according to the first embodiment;

FIG. 16 is a diagram showing an exemplary operation according to the first embodiment;

FIG. 17 is a diagram showing an exemplary operation according to the first embodiment;

FIG. 18 is a diagram illustrating an overall configuration of a system according to a second embodiment;

FIG. 19 is a diagram illustrating a functional configuration of a relay apparatus according to the second embodiment;

FIG. 20 is a sequence diagram showing a sequence of processing on the system according to the second embodiment;

FIG. 21 is a table showing an exemplary data structure of user information managed by an authentication server according to a third embodiment; and

FIG. 22 is a flowchart showing a sequence of authentication processing according to the third embodiment.

### DETAILED DESCRIPTION OF THE INVENTION

With reference to the drawings, embodiments of the present disclosure are described below. Note that the embodiments below are examples to describe the present disclosure. The technical scope of the invention recited in the claims shall not be limited to the descriptions below.

### 1. FIRST EMBODIMENT

### 1.1 Overall Configuration

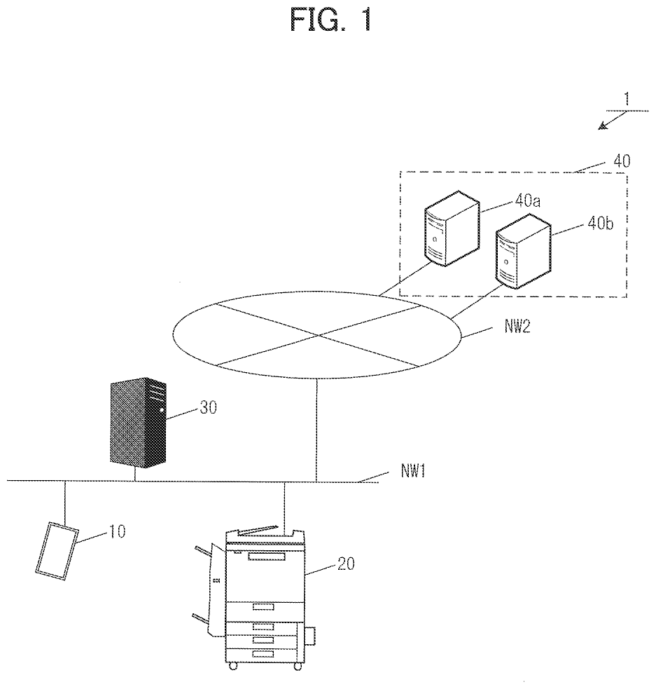

With reference to FIG. 1, an overall configuration of a system 1 according to this embodiment is described. As illustrated in FIG. 1, the system 1 includes: a terminal apparatus 10; an image forming apparatus 20; an authentication server 30; and an IdP server 40.

The terminal apparatus 10, the image forming apparatus 20, the authentication server 30, and the IdP server 40 are connected together through a network. For example, as illustrated in FIG. 1, the terminal apparatus 10, the image forming apparatus 20, and the authentication server 30 are connected together through an NW1; that is, a first network. Moreover, each of the apparatuses connected to the NW1 and the IdP server 40 are connected together through an NW2; that is, a second network. Here, the NW1 is, for example, a local area network (LAN) connecting one another apparatuses installed in a predetermined facility. Moreover, the NW2 is an external network such as the Internet. Note that a technique to connect one another the apparatuses included in the system 1 shall not be limited to the technique illustrated in FIG. 1. For example, each of the apparatuses included in the system 1 may be connected to the Internet.

The terminal apparatus 10 is used by a user. For example, the terminal apparatus 10 of this embodiment is a typical terminal apparatus operating on an application installed in the apparatus. The terminal apparatus 10 is an information processing apparatus such as a smartphone, a smartwatch, a tablet, and a personal computer (PC).

The image forming apparatus 20 can form (print) an image on a recoding medium such as a recording paper sheet. For example, the image forming apparatus 20 is a digital multi-function printer/peripheral (MFP) having, for example, a copy function, a print function, a scan function, and a mail-transmission function.

The authentication server 30 is an information processing apparatus (a first server apparatus) authenticating a user who uses the image forming apparatus 20. Moreover, the IdP server 40 is an information processing apparatus (an identity provider, an IdP; namely, a second server apparatus) providing such services as: authentication of a user who uses a Web service and a cloud service; and management of user information. The IdP server 40 is, for example, an apparatus found on the cloud (on the Internet).

The IdP server 40 obtains, from another apparatus (e.g. the terminal apparatus 10), information required to authenticate the user, and authenticates the user. If the user is successfully authenticated, the IdP server 40 issues security information such as an access token. That is, the security information (e.g. the access token) indicates that the user has been successfully authenticated. The IdP server 40 transmits the information on the authenticated user and the access token to the apparatus that has transmitted the information required to authenticate the user. The apparatus, which has transmitted the information required to authenticate the user, receives the access token, so that the apparatus can determine that the user has been authenticated. In this embodiment, the security information is described as the access token.

The authentication server 30 and the IdP server 40 are information processing apparatuses; that is, computers such as, for example, a PC and a server. Note that each of the authentication server 30 and the IdP server 40 may be configured of a plurality of information processing apparatuses, or may be a virtual server implemented on any given information processing apparatus. Moreover, to the network NW2, a plurality of IdP servers 40 (40a and 40b) may be connected for respective services. For example, connected to the network NW2 may be: the IdP server 40a providing a service to authenticate a user using a cloud service of a company A; and the IdP server 40b providing a service to authenticate a user using a cloud service of a company B.

### 1.2 Functional Configuration

### 1.2.1 Terminal Apparatus

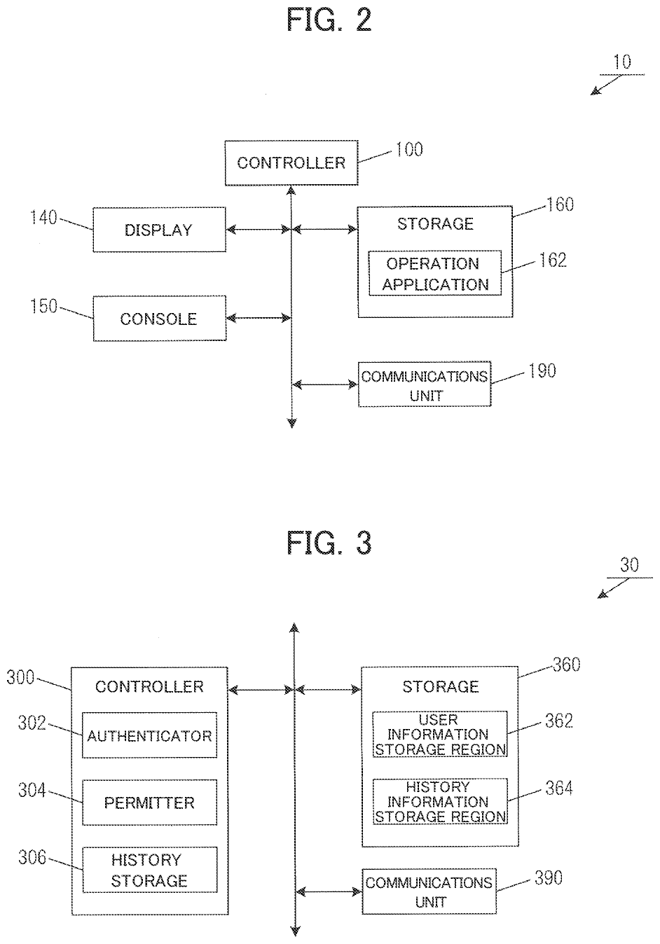

With reference to FIG. 2, a functional configuration of the terminal apparatus 10 is described. As illustrated in FIG. 2, the terminal apparatus 10 includes: a controller 100; a display 140; a console 150; a storage 160; and a communications unit 190.

The controller 100 controls an entirety of the terminal apparatus 10. The controller 100 reads and executes various kinds of programs stored in the storage 160 to implement various kinds of functions. The controller 100 includes one or a plurality of arithmetic apparatuses (e.g. a central processing unit; namely, a CPU).

The display 140 displays various kinds of information. The display 140 is a display device such as, for example, a liquid crystal display (an LCD), an organic electro-luminescence (EL) display, and a micro light-emitting diode (LED) display.

The console 150 receives an operation of a user using the terminal apparatus 10. The console 150 is configured of an input apparatus such as a touch sensor. Techniques to detect input with the touch sensor may be typical detection techniques using, for example, a resistance film, an infrared ray, electromagnetic induction, and electrostatic capacitance. Note that the terminal apparatus 10 may be provided with a touch panel integrally formed of the display 140 and the console 150.

The storage 160 stores various kinds of programs required for the operation of the terminal apparatus 10, and various kinds of data. The storage 160 is, for example, a storage device including such a semiconductor memory as a solid-state drive (SSD), and a hard disk drive (HDD).

The storage 160 stores an operation application 162. The operation application 162 is an application for operating the image forming apparatus 20. For example, the operation application 162 causes the controller 100 to implement such functions as: transmitting, to the image forming apparatus 20, information on image data and specifics of processing to be executed; and managing the image forming apparatus 20. Note that the image data indicates an image to be formed by the image forming apparatus 20. Moreover, when transmitting the image data to the image forming apparatus 20, the operation application 162 may transmit, together with the image data, setting information (print information) for forming an image based on the image data.

Moreover, the operation application 162 of this embodiment causes the controller 100 to implement a function to transmit and receive information to be used for the authentication of the user. The function is implemented for usage of the user authentication service provided from the IdP server 40. For example, the operation application 162 provides the controller 100 with such functions that the controller 100: causes the display 140 to display a screen on which the user enters information (e.g. an account name and a password) required for the user authentication by the IdP server 40; and receives an authentication result from the IdP server 40. That is, the operation application 162 causes the controller 100 to act as an interface of the IdP server 40. Such a function allows the user to use the user authentication service provided from the IdP server 40 through the operation application 162.

The communications unit 190 communicates with such an external apparatus as the image forming apparatus 20. The communications unit 190 is configured of, for example, a network interface card (NIC) to be used for a wired/wireless LAN, and a communications module connectable to long term evolution (LTE)/LTE-advanced (LTE-A)/license-assisted access using LTE (LAA)/5G lines.

### 1.2.2. Authentication Server

Next, a functional configuration of the authentication server 30 is described. The authentication server 30 according to this embodiment manages (stores) information (user information) on a user who uses the image forming apparatus 20, and the functions of the image forming apparatus 20 that the user is granted a privilege to use. The authentication server 30 authenticates the user in accordance with information (transmission information) transmitted from such an external apparatus as the IdP server 40.

As illustrated in FIG. 3, the authentication server 30 according to this embodiment includes: a controller 300; a storage 360; and a communications unit 390.

The controller 300 controls an entirety of the authentication server 30. The controller 300 reads and executes various kinds of programs stored in the storage 360 to implement various kinds of functions. The controller 300 includes one or a plurality of arithmetic apparatuses (e.g. a CPU).

The controller 300 executes the programs stored in the storage 360, to function as an authenticator 302, a permitter 304, and a history storage 306.

The authenticator 302 authenticates the user who uses the image forming apparatus 20. The processing executed on the authenticator 302 will be described later.

The permitter 304 grants the user, who uses the image forming apparatus 20, privileges to use the functions and resources provided to the image forming apparatus 20. The processing executed on the permitter 304 will be described later.

The history storage 306 stores, in a history information storage region 364, information (history information) on the usage of the image forming apparatus 20. The history information includes, for example, a user ID for identification of the user using the image forming apparatus 20, a function used by the user, a setting for forming the image, a count of paper sheets on which the image is formed (a count of sheets printed), and a time period taken to carry out the formation of the image.

The storage 360 stores various kinds of programs required for the operation of the terminal apparatus 30, and various kinds of data. The storage 360 is configured of, for example, a storage device including such a semiconductor memory as an SSD, and an HDD.

The storage 360 includes, as storage regions, a user information storage region 362, and the history information storage region 364 to store history information.

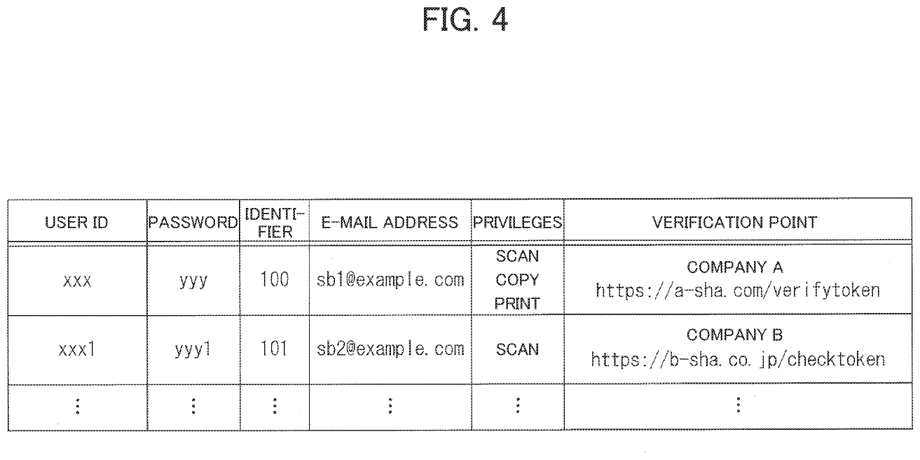

The information storage region 362 stores information on the user (user information, and account information on the user who uses the image forming apparatus 20) who uses the image forming apparatus 20. The user information to be stored in the user information storage region 362 includes, for example, as illustrated in FIG. 4, a user ID (e.g. “xxx”) for identification of the user who uses the image forming apparatus 20, a password (e.g. “yyy”) to be used for authentication of the user, an identifier (e.g. “100”) for identification of history information on the user, an e-mail (electronic mail) address (e.g. sb1@example.com) of the user, privileges (e.g. “SCAN, COPY”) granted to the user, and a verification point (e.g. “the company A, https://a-sha.com/verifytoken”) that is information on a server apparatus and a service receiving a request to verify whether an access token to be issued by the IdP server 40 is correct.

Here, the user ID, the e-mail address, and the identifier included in the user information stored in the user information storage region 362 are identification information to be used for identification of the user who uses the image forming apparatus 20. The identification information is used on the authentication server 30 and the image forming apparatus 20 to identify the user who uses the image forming apparatus 20.

The user ID (first identification information) of this embodiment is, for example, a user-settable character string. The first identification information may be information with which the image forming apparatus 20 and the authentication server 30 can identify the user. The first identification information may be such information as an account name and a user name.

Moreover, the user information managed by the authentication server 30 includes, as illustrated in FIG. 4, an e-mail address. Here, in this embodiment, the e-mail address is information associated with one of information items included in the user information stored in the user information storage region 362. That is, in this embodiment, the e-mail address is information (second identification information) that can be used for identification of the user of the image forming apparatus 20.

Furthermore, the second identification information is managed as information on the user, and transmitted from the IdP server 40 to another apparatus. For example, when the IdP server 40 authenticates the user in the user authentication service provided by the IdP server 40, the e-mail address is transmitted together with an access token. An apparatus receiving the e-mail address and the access token from the IdP server 40 can determine that the user who relates to the e-mail address transmitted from the IdP server 40 has been authenticated by the IdP server 40. Here, in the authentication server 30, the e-mail address is information stored in the user information. Moreover, the e-mail address is information to be transmitted from the IdP server. Hence, the e-mail address is information interchangeably available between the authentication server 30 and the IdP server 40. Furthermore, the e-mail address is information capable of uniquely defining the user of the image forming apparatus 20. Hence, the authenticator 302 can associate the e-mail address to be transmitted from the IdP server 40 with the user of the image forming apparatus 20.

Meanwhile, the user ID (the account name) and the password are information unique to the system (unique to the service), and are separately stored in each of the authentication server 30 and the IdP server 40. Hence, the user ID and the password are not interchangeable between the authentication server 30 and the IdP server 40. Moreover, in this embodiment, the identifier is stored in the authentication server 30 but not in the IdP server 40. Hence, it is unknown whether the identifier is found in a user-management system other than the authentication server 30. Even if found, the identifier is not interchangeable between the authentication server 30 and the IdP server 40. Furthermore, the access token is a random character string to be issued by the IdP server 40. Hence, the authentication server 30 cannot previously store the access token, and the access token is not interchangeable between the authentication server 30 and the IdP server 40.

Note that the second identification information (interchangeable information) may be information other than an e-mail address, as long as the information is managed and transmitted by the IdP server 40, and stored in the authentication server 30 as the user information.

The identifier (third identification information) is, for example, information to be automatically provided by the authentication server 30 when the user is registered in the authentication server 30. The identifier may be such information as a serial number, a character string created by a predetermined rule, and ash value corresponding to the user information.

The privileges are information indicating, among the functions of the image forming apparatus 20, a function that the user is granted a privilege to use. In this embodiment, the privileges of the user information store information below:
“SCAN” indicating that the user is granted a privilege to use the scan function;
“COPY” indicating that the user is granted a privilege to use the copy function; and
“PRINT” indicating that the user is granted a privilege to use the print function.

Note that the user information may store information indicating a privilege other than the above privileges. For example, the user information may store information indicating available region of the storage 360 (indicating a privilege to use a resource of the storage 360).

Moreover, the verification point, which is relied on by the authentication server 30, is information indicating where to conduct the verification of the access token. The verification point to be stored includes such attributes as: an address and a name of a server apparatus that verifies the access token (e.g. the ID server 40); an address of an end point of an application programming interface (API) that verifies the access token; and a name of a service that verifies the access token. This embodiment is based on the assumption that a verification request (an access token verification request) is transmitted to the verification point. Then, the access token is verified by the verification point, and the verification result of the access token is transmitted from the verification point.

Note that the user information stored in the user information storage region 362 may store information other than the information shown in FIG. 4.

The communications unit 390 communicates with such external apparatuses as the image forming apparatus 20 and the IdP server 40. The communications unit 390 is configured of, for example, a communications apparatus and a communications module such as an NIC to be used on a wired/wireless LAN.

### 1.2.3 Image Forming Apparatus

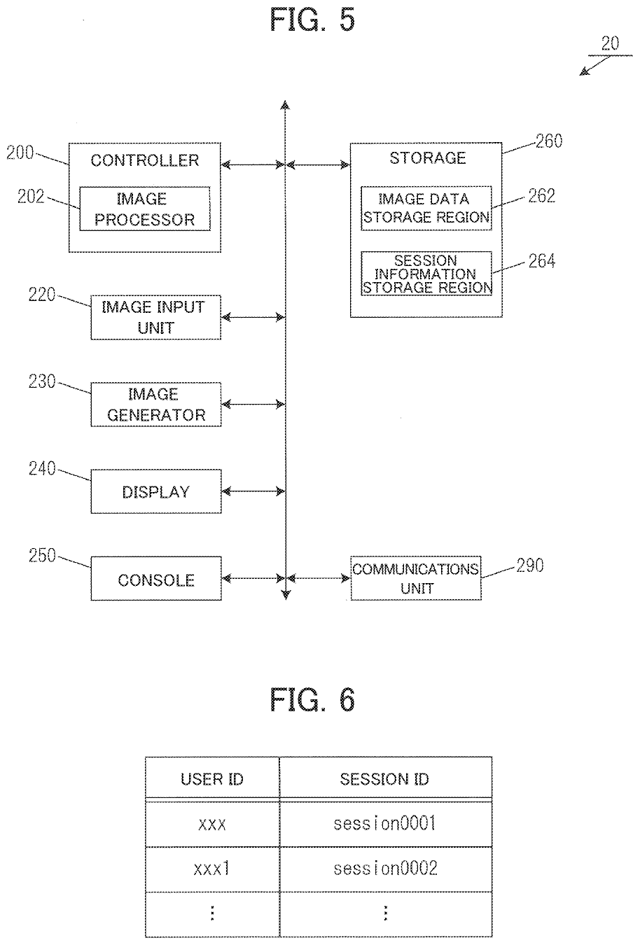

With reference to FIG. 5, a functional configuration of the terminal apparatus 20 is described. As illustrated in FIG. 5, the image forming apparatus 20 includes: a controller 200; an image input unit 220; an image generator 230; a display 240; a console 250; a storage 260; and a communications unit 290.

The controller 200 controls an entirety of the terminal apparatus 20. The controller 200 reads and executes various kinds of programs stored in the storage 260 to implement various kinds of functions. The controller 200 includes one or a plurality of arithmetic apparatuses (e.g. a CPU).

The controller 200 executes the programs stored in the storage 260, to function as an image processor 202. The image processor 202 executes processing for various kinds of images. For example, the image processor 202 executes sharpening processing and grayscale conversion processing on an image read by the image input unit 220.

The image input unit 220 inputs image data into the image forming apparatus 20. For example, the image input unit 220 is configured of such an apparatus as a scan apparatus capable of reading an image and generating image data. The scan apparatus, for example, converts the image into an electric signal with an image sensor such as a charge coupled device (CCD) and a contact image sensor (CIS), and quantizes and encodes the electric signal to generate digital data.

Note that the image input unit 220 may be configured of a universal serial bus (USB) memory, and an interface (a terminal) to read out the image data stored in such a storage medium as an SD card. Moreover, the communications unit 290, which establishes connection to another apparatus, may be used to input the image data from the other apparatus.

The image generator 230 forms (prints) an image on a recoding medium such as a recording paper sheet. The image generator 230 is configured of, for example, a xerographic laser printer.

The display 240 displays various kinds of information. The display 240 is configured of such a display device as, for example, an LCD, an organic EL panel, and a micro LED display.

The console 250 receives an operation of a user using the terminal apparatus 20. The console 250 is configured of an input apparatus such as a touch sensor. Techniques to detect input with the touch sensor may be typical detection techniques using, for example, a resistance film, an infrared ray, electromagnetic induction, and electrostatic capacitance. Note that the image forming apparatus 20 may be provided with a touch panel integrally formed of the display 240 and the console 250.

The storage 260 stores various kinds of programs required for the operation of the terminal apparatus 20, and various kinds of data. The storage 260 is configured of, for example, a storage device including such a semiconductor memory as an SSD, and an HDD.

The storage 260 includes, as storage regions, an image data storage region 262, and a session information storage region 264.

The image data storage region 262 stores image data. Note that the image data stored in the image data storage region 262 may be associated with setting information to be used for forming (printing) an image based on the image data.

The session information storage region 264 stores information (session information) to be used for managing a session between the image forming apparatus 20 and the terminal apparatus 10. The session information stores, for example, as illustrated in FIG. 6, a user ID (e.g. “xxx”) as identification information and a session ID (e.g. “session0001”) for identification of the communications session with the user.

The communications unit 290 communicates with such external apparatuses as the terminal apparatus 10 and the authentication server 30. The communications unit 290 is configured of, for example, a communications apparatus and a communications module such as an NIC to be used on a wired/wireless LAN.

### 1.2.4. IdP Server

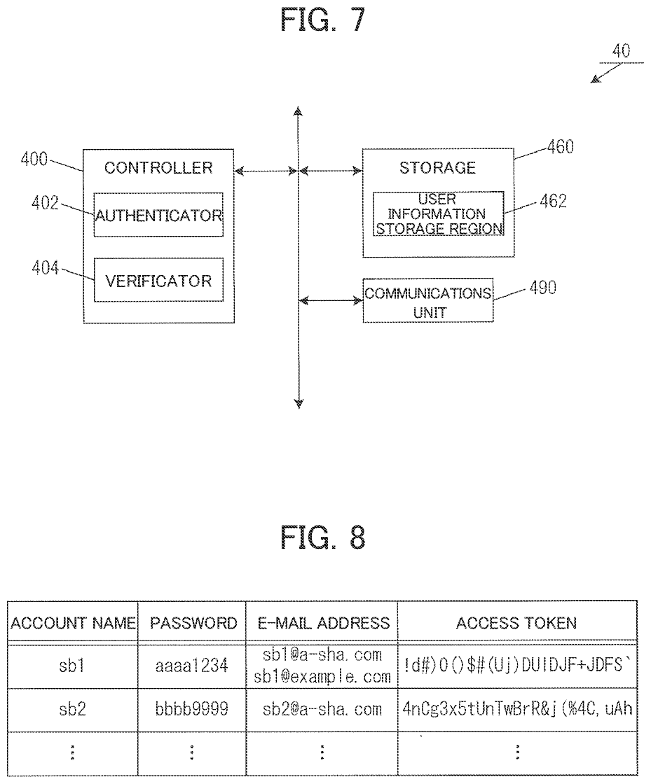

Next, a functional configuration of the IdP server 40 is described. As illustrated in FIG. 7, the IdP server 40 according to this embodiment includes: a controller 400; a storage 460; and a communications unit 490.

The controller 400 controls an entirety of the IdP server 40. The controller 400 reads and executes various kinds of programs stored in the storage 460, to implement various kinds of functions. The controller 400 includes one or a plurality of arithmetic apparatuses (e.g. a CPU).

The controller 400 executes the programs stored in the storage 460, to function as an authenticator 402 and a verificator 404.

The authenticator 402 receives, from an external apparatus, information to be used for authentication of the user. In accordance with the information, the authenticator 402 provides a service to authenticate the user. For example, the authenticator 402 receives, through the communications unit 490, information to be used for authentication of the user. In accordance with the received information, the authenticator 402 determines whether the user transmitting the information is a valid user.

Here, if the authenticator 402 determines that the user transmitting the information to be used for authentication of the user is a valid user, the authenticator 402 authenticates the user and issues an access token. The access token is, for example, a character string derived with a predetermined technique and expression, or a character string created in accordance with a predetermined format. Moreover, the authenticator 402 transmits, as transmission information, the issued access token and attribute information on the authenticated user (e.g. an e-mail address of the user) to the apparatus that has transmitted the information used for the authentication of the user.

The verificator 404 receives an access token from an external apparatus through the communications unit 490, verifies (determines) whether the access token is a correct access token, and transmits a result of the verification to the external apparatus.

For example, if the access token received from the external apparatus is a character string derivable with a technique and an expression to be used by the authenticator 402, the verificator 404 determines that the access token is issued by the authenticator 402. Note that, if the access token received from the external apparatus is a character string created in accordance with a predetermined format, the verificator 404 may determine that the access token has been issued by the authenticator 402. If the verificator 404 determines that the access token received from the external apparatus has been issued by the authenticator 402, the verificator 404 determines that the access token received from the external apparatus is correct.

The storage 460 stores various kinds of programs required for the operation of the IdP server 40, and various kinds of data. The storage 460 is configured of, for example, a storage device including such a semiconductor memory as an SSD, and an HDD.

The storage 460 includes, as a storage region, a user information storage region 462. The user information storage region 462 stores information (user information) on a user (a target user of authentication) who uses a service to be provided by the IdP server 40. The user information to be stored in the user information storage region 462 includes, for example, as illustrated in FIG. 8, an account name (e.g. “sb1”) for identification of the user who uses the service to be provided by the IdP server 40, a password (e.g. “aaaa1234”) to be used for authentication of the user, an e-mail address (e.g. “sb1@a-sha.com, sb1@example.com”) that is attribute information on the user, and an access token (e.g. “!d#)O()$#(Uj)DUIDJF+JDFS′”) issued to the user.

Of the user information to be stored in the IdP server 40, the account name and the password are information to be used on the IdP server 40 for authentication of the user. Note that the information to identify the user who uses the service provided by the IdP server 40 may be information other than the account name. The information may be such information as an identifier (e.g. a serial number and a character string created by a predetermined rule), and a user name. Moreover, the user information stored in the user information storage region 462 may store a plurality of e-mail addresses. Furthermore, the user information stored in the user information storage region 462 may store information other than the information shown in FIG. 8.

The communications unit 490 communicates with such an external apparatus as the authentication server 30. The communications unit 490 is configured of, for example, a communications apparatus and a communications module such as an NIC to be used on a wired/wireless LAN.

### 1.3 Sequence of Processing

### 1.3.1 Sequence of Entire System

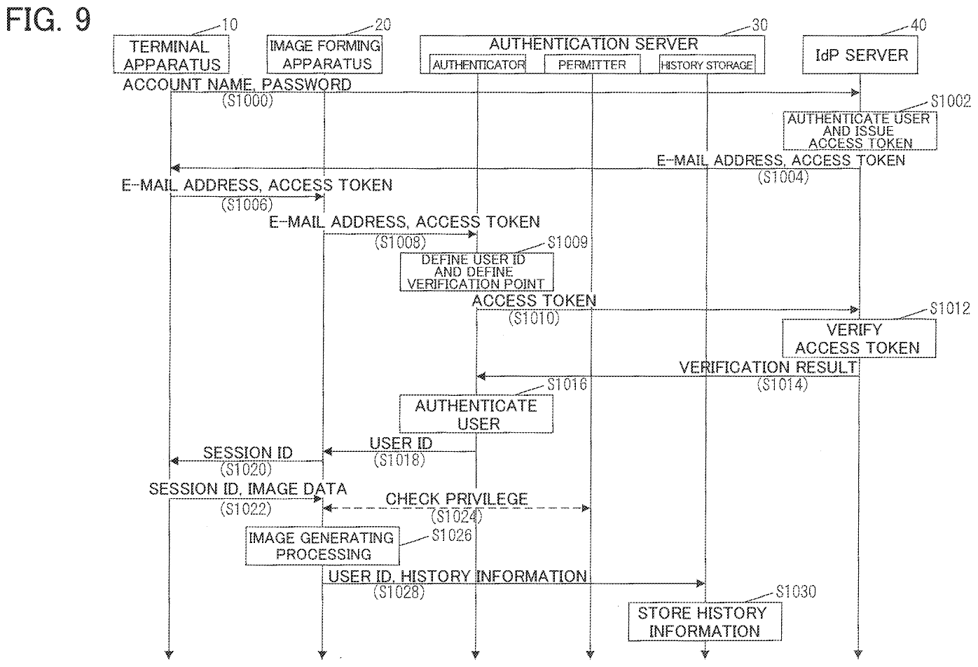

Next, with reference to FIG. 9, a sequence of processing on the system 1 according to this embodiment is described. Note that the controller 100 of the terminal apparatus 10 has predetermined functions implemented by the operation application 162. Moreover, the information to be transmitted together with an access token when the user is authenticated by the IdP server 40 is an e-mail address.

First, the controller 100 of the terminal apparatus 10 obtains an account name and a password; that is, information to be used for authentication of the user by the IdP server 40, and transmits the obtained account name and password to the IdP server 40 (S1000). For example, the controller 100 causes the display 140 to display a screen on which the user enters the account name and the password. Next, upon receiving from the user an instruction that the entry is to end, the controller 100 obtains the account name and the password entered by the user, and transmits the obtained account name and password to the LIP server 40 through the communications unit 190.

Next, the controller 400 (the authenticator 402) of the IdP server 40 authenticates the user, using the received account name and password. If the controller 400 determines that the user is valid, the controller 400 issues an access token (S1002). For example, if the authenticator 402 successfully obtains, from the user information storage region 462, user information storing the user ID and the password received from the terminal apparatus 10, the authenticator 402 determines that the user corresponding to the obtained user information is valid, and authenticates the user.

Next, the controller 400 (the authenticator 402) transmits, to the terminal apparatus 10, transmission information including: an e-mail address; that is, attribute information on the user authenticated at S1002; and the access token issued at S1002 (S1004). Note that the authenticator 402 may read out the user information obtained at S1002 to obtain information on the e-mail address of the authenticated user.

Next, the controller 100 of the terminal apparatus 10 transmits the e-mail address (the attribute information on the user) and the access token, both received at S1004, through the communications unit 190 to the image forming apparatus 20 (S1006). Hence, the controller 100 sends the image forming apparatus 20 an authentication request based on the information received from the IdP server 40. The image forming apparatus 20 can obtain the transmission information transmitted from the IdP server 40.

Next, the controller 200 of the terminal apparatus 20 transmits the e-mail address (the attribute information on the user) and the access token, both received at S1006, through the communications unit 290 to the authentication server 30 (S1008). Hence, the image forming apparatus 20, which has received the authentication request from the terminal apparatus 10, transmits the transmit information transmitted from the IdP server 40. The authentication server 30 obtains (receives), from the image forming apparatus 20, the transmission information transmitted from the IdP server 40 and obtained by the image forming apparatus 20.

Next, the controller 300 (the authenticator 302) of the authentication server 30 obtains, from the user information storage region 362, the user information storing the received e-mail address, and defines a user ID and a verification point (S1009).

Here, the e-mail address is associated with one of the user information items included in the user information stored in the user information storage region 362. Hence, if the authenticator 302 can read out, from the user information storage region 362, the user information including the same information as the e-mail address received at S1008, the authenticator 302 can determine that the user corresponding to the user information is managed as a user (a managed user) who uses the image forming apparatus 20. Moreover, the authenticator 302 obtains the user ID and information on the verification point, both stored in the read user information, such that the authenticator 302 can define the user ID and the verification point.

Hence, the authenticator 302 checks whether the user information, storing the e-mail address received from the terminal apparatus 10 that has sent the authentication request, is stored, and determines whether the user in the authentication request is the managed user who is managed on the authentication server 30. That is, if the e-mail address is found in a data base of the user information; that is, the user information storage region 362, the authenticator 302 determines that the user in the authentication request is the managed user. Meanwhile, if the e-mail address is not found in the user information storage region 362, the authenticator 302 determines that the user in the authentication request is not the managed user.

Next, in order to determine whether the access token is correct, the controller 300 (the authenticator 302) of the authentication server 30 transmits the access token through the communications unit 390 to the verification point obtained at S1009, thereby sending a verification request. Here, if the verification point is the IdP server 40, the authenticator 302 transmits the access token to the IdP server 40 (S1010).

The controller 400 (the verificator 404) of the IdP server 40 verifies whether the access token received at S1010 is correct (S1012). Then, the controller 400 (the verificator 404) transmits a verification result through the communications unit 490 to the authentication server 30 that has transmitted the access token at S1010 (S1014).

The controller 300 (the authenticator 302) of the authentication server 30 receives the verification result from the verification point (e.g. the IdP server 40), and authenticates the user in accordance with the result of the verification (S1016). For example, if the authenticator 302 receives, from the IdP server 40, a verification result indicating that the access token is correct, the authenticator 302 authenticates the user corresponding to the user ID defined at S1009. Hence, if the authenticator 302 can correctly verify the access token (security information) transmitted from the IdP server 40, the authenticator 302 can authenticate the user. That is, the authentication server 30 uses the authentication result determined by another apparatus; that is, the IdP server 40, to authenticate the user who uses the image forming apparatus 20.

Then, the controller 300 (the authenticator 302) transmits identification information on the user, authenticated at S1016, through the communications unit 390 to the image forming apparatus 20 that has transmitted the e-mail address (the attribute information on the user) and the access token (S1018). Note that, in this embodiment, the identification information on the authenticated user is a user ID (the first identification information). Moreover, the image forming apparatus 20 receives, from the authentication server 30, such identification information as the user ID, so that the image forming apparatus 20 can find out that the authentication server 30 has authenticated the user who uses the image forming apparatus 20.

Then, the controller 200 of the image forming apparatus 20 issues a session ID. The controller 200 stores, in the session information storage region 264, session information including the issued session ID and the user ID that is the identification information received at S1018. Then, the controller 200 of the image forming apparatus 20 transmits the issued session ID through the communications unit 290 to the terminal apparatus 10 that has transmitted the e-mail address and the access token at S1006 (S1020). The session ID is information (communications identification information) to be used in the communications between the terminal apparatus 10 and the image forming apparatus 20. The image forming apparatus 20 uses the session ID to identify the terminal apparatus 10; namely, a communications target. Moreover, through the communications between the terminal apparatus 10 and the image forming apparatus 20 using the session ID, the image forming apparatus 20 can find out that the terminal apparatus 10; namely, a communications target, is the user (the authenticated user) allowed to use the image forming apparatus 20.

Then, the controller 100 of the terminal apparatus 10 transmits image data and the session ID, received at S1020, through the communications unit 190 to the image forming apparatus 20 (S1022). For example, when the user selects an image and gives an instruction to print the image, the controller 100 transmits, to the image forming apparatus 20, the image data of the selected image together with the session ID.

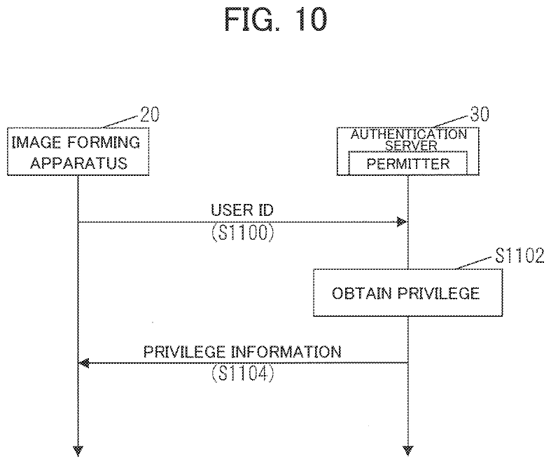

Then, the image forming apparatus 20 and the authentication server 30 execute authorization check processing to check a privilege of the user transmitting the image data (S1024). A sequence of the privilege check processing is described, with reference to FIG. 10.

First, the controller 200 of the image forming apparatus 20 transmits the user ID to the authentication server 30 (S1100). For example, the controller 200 of the image forming apparatus 20 obtains, from the session information storage region 264, the session information storing the session ID received at S1022. Moreover, the controller 200 transmits the user ID, included in the obtained session information, through the communications unit 290 to the authentication server 30.

The controller 300 (the permitter 304) of the authentication server 30 receives the user ID from the image forming apparatus 20 through the communications unit 390, and obtains the privilege of the user identified with the user ID (S1102). For example, the permitter 304 obtains, from the user information storage region 362, the user information including the user ID received from the image forming apparatus 20, and obtains information on the privilege included in the obtained user information.

Then, the controller 300 (the permitter 304) transmits, to the image forming apparatus 20 that has transmitted the user ID at S1100, privilege information that is information indicating the privilege obtained at S1002. The privilege information includes information indicating such privileges as, for example, “SCAN”, “COPY”, and “PRINT”.

With reference to the privilege information received from the authentication server 30, the controller 200 of the image forming apparatus 20 can determine whether the user, who has transmitted the image data at S1022 of FIG. 9, is granted a privilege to use the print function.

With reference back to FIG. 9, then, if the user who has transmitted the image data at S1022 is granted a privilege to use the print function, the controller 200 executes image generating processing in which the image generator 230 generates an image based on the image data (S1026). Note that, if the controller 200 has information on a setting associated with the image data, the controller 200 performs control to generate the image in accordance with the setting.

Note that, when the image generating processing ends, the controller 200 transmits the user ID and the history information through the communications unit 290 to the authentication server 30 (S1028). The controller 300 (the history storage 306) of the authentication server 30 stores, in the history information storage region 364, the history information received from the image forming apparatus 20 (S1030).

### 1.3.2 Sequence of Processing on Terminal Apparatus

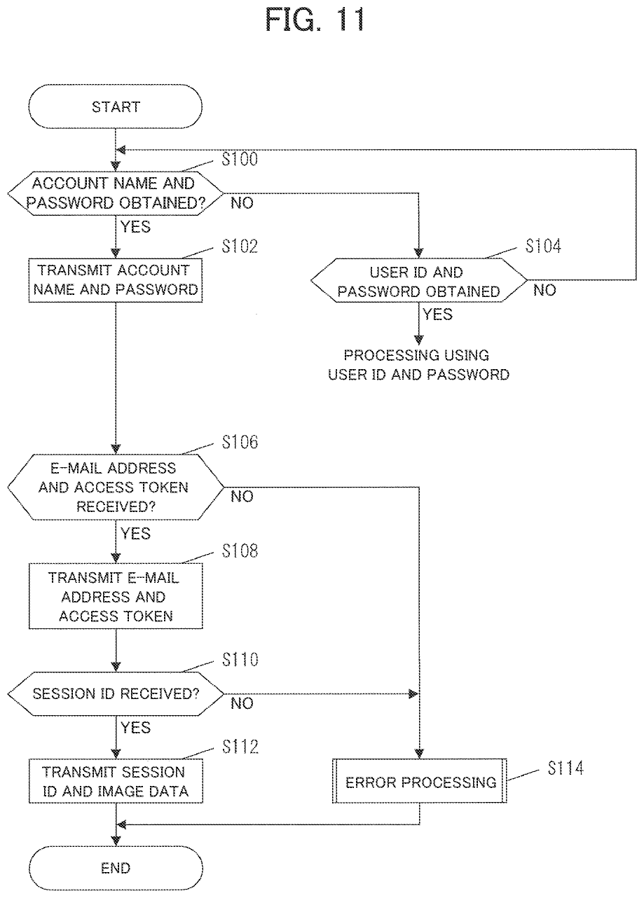

Next, with reference to FIG. 11, processing executed by the terminal apparatus 10 is described. Note that the controller 100 of the terminal apparatus 10 runs the operation application 162 to execute processing shown in FIG. 11.

First, the controller 100 determines whether an account name and a password obtained have been obtained (Step S100). The account name and the password are information to be used on the IdP server 40 for authentication of the user. For example, the controller 100 causes the display 140 to display a field to enter the account name and a field to enter the password. Here, when the user enters the information in the fields and carries out an operation to confirm the entered information, the controller 100 obtains the account name and the password.

If the controller 100 obtains the account name and the password, the controller 100 transmits the obtained user ID and password through the communications unit 190 to the IdP server 40 (Yes at Step S100 to Step S102).

Then, if the controller 100 receives, from the IdP server 40 through the communications unit 190, transmission information; that is, the e-mail address and the access token, the controller 100 transmits the received e-mail address and access token to the image forming apparatus 20 (Yes at Step S106 to Step S108). Hence, the controller 100 sends the image forming apparatus 20 an authentication request based on the information received from the IdP server 40.

Moreover, the controller 100 determines whether a session ID has been received from the image forming apparatus 20 through the communications unit 190 (Step S110). The case where the controller 100 receives the session ID from the image forming apparatus 20 is when the user is authorized in response to the authentication request sent to the image forming apparatus 20 at Step S106, and the user is allowed to use the image forming apparatus 20. In such a case, the controller 100 transmits the session ID and the image data, selected by the user, through the communications unit 190 to the image forming apparatus 20 (Yes at Step S110 to Step S112).

Note that if, at Step S106, the controller 100 cannot receive the e-mail address and the access token from the IdP server 40, the controller 100 executes error processing (No at Step S106 to Step S114). Moreover, if, at Step S110, the controller 100 cannot receive the session ID from the image forming apparatus 20, the controller 100 executes error processing (No at Step S110 to Step S114).

The case where the controller 100 cannot receive the e-mail address or the access token from the IdP server 40 is, for example, when the controller 100 receives such a message as an error message from the IdP server 40, and when the controller 100 fails to communicate with the IdP server 40. Moreover, the case where the controller 100 cannot receive the session ID from the image forming apparatus 20 is, for example, when the controller 100 receives such a message as an error message from the image forming apparatus 20, and when the controller 100 fails to communicate with the image forming apparatus 20.

The error processing is processing to notify the user that the error has developed, encourage the user to redo the operation, and finish the processing shown in FIG. 11. For example, as the error processing, the controller 100 executes processing to display an error message on the display 140. In such a case, the image data is not transmitted from the terminal apparatus 10 to the image forming apparatus 20. Hence, the user cannot cause the image forming apparatus 20 to print out an image based on the image data.

Note that, if, at Step S100, the controller 100 does not obtain the account name or the password, the controller 100 determines whether identification information (e.g. the user ID) has been obtained (No at Step S100 to Step S104). The identification information identifies the user who uses the image forming apparatus 20. For example, the controller 100 causes the display 140 to display a field to enter the user ID and a field to enter the password. Here, when the user enters the information in the fields and carries out an operation to confirm the entered information, the controller 100 obtains the user ID and the password. That is, the user controller 100 sends a conventional authentication request, using the user ID and the password. Hence, the controller 100 can select either the user authentication on the authentication server 30 using the user ID and the password, or the user authentication on the IdP server 40 using the account name and the password.

If the controller 100 receives the user ID and the password, the controller 100 executes processing using the user ID and the password (Yes at Step S104). For example, the controller 100 transmits the obtained user ID and password through the communications unit 190 to the image forming apparatus 20. Hence, the controller 100 sends an authentication request to the image forming apparatus 20, and receives a session ID from the image forming apparatus 20. Moreover, the controller 100 transmits image data and the session ID, received from the image forming apparatus 20, through the communications unit 190 to the image forming apparatus 20. Thanks to such processing, the terminal apparatus 10 can perform authentication using the user ID and the password, and, after that, transmit the image data to the image forming apparatus 20.

Note that, if at Step S104, the controller 100 does not obtain the user ID or the password, the processing returns to Step S100 (No at Step S104 to Step S100).

### 1.3.3 Sequence of Processing on Image Forming Apparatus

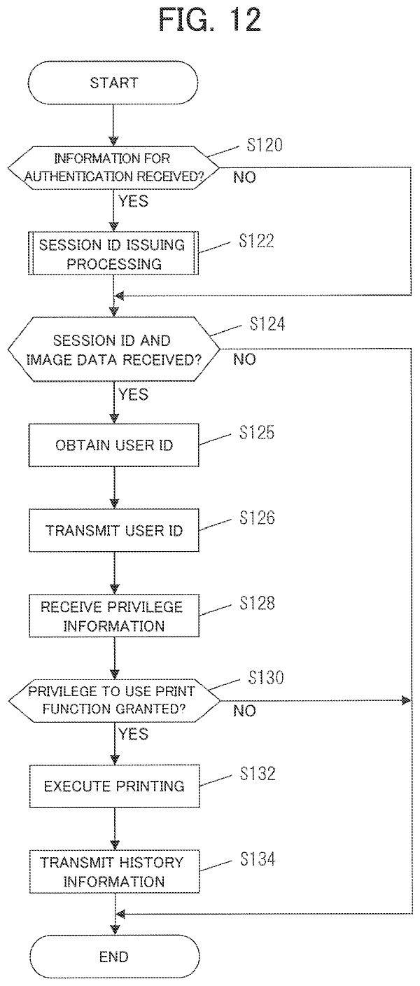

Next, with reference to FIG. 12, processing executed by the image forming apparatus 20 is described. First, the controller 200 determines whether an authentication request has been sent, and information for authentication has been received, from the image forming apparatus 10 through the communications unit 290 (Step S120). The information for authentication is either one of information sets below:

(a) an access token and an e-mail address; or
(b) a user ID and a password.

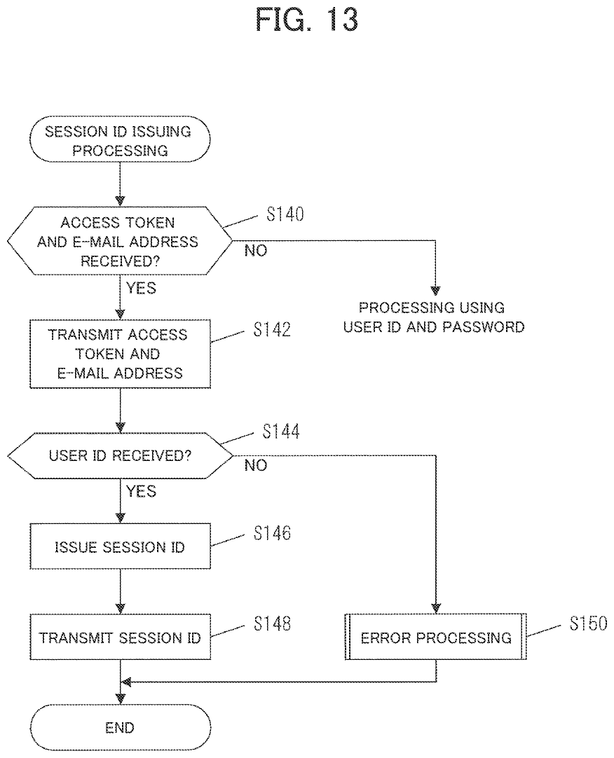

If the controller 200 receives the information for authentication, the controller 200 authenticates the user, using the information received at Step S120, and executes processing (session ID issuing processing) to issue a session ID corresponding to the authenticated user (Yes at Step S120 to Step S122). The session ID issuing processing is described with reference to FIG. 13.

First, the controller 200 determines whether an access token and an e-mail address have been received (Step S140). The access token and the e-mail address are the transmission information to be transmitted from the IdP server 40 as information for authentication.

If the controller 200 receives the access token and the e-mail address, the controller 200 transmits the access token and the e-mail address through the communications unit 290 to the authentication server 30 (Yes at Step S140 to Step S142).

Then, the controller 200 determines whether a user ID has been received from the authentication server 30, as an authentication result of the user authentication executed by the authentication server 30 in accordance with the access token and the e-mail address transmitted at Step S142 of FIG. 12 (Step S144). Here, the case where the user ID is received from the authentication server 30 is when the user is correctly authenticated, using the access token and the e-mail transmitted at Step S142 (when the authentication result determined by the authentication server 30 is correct).

If the controller 200 receives the user ID, the controller 200 authenticates the user and issues the session ID (Yes at Step S144 to Step S146). That is, the controller 200 authenticates the user to be authenticated by the authentication request from the terminal apparatus 10, and allows the user to use the image forming apparatus 20. Here, the controller 200 stores, in the session information storage region 264, session information including the session ID issued at Step S144 and the user ID; that is, identification information received at Step S144. Moreover, the controller 200 transmits the session ID, issued at Step S146, through the communications unit 290 to the terminal apparatus 10 (Step S148).

Note that if, at Step S144, the controller 200 does not receive the user ID, the controller 200 determines that the authentication server 30 does not authenticate the user correctly (that the authentication result determined by the authentication server 30 is incorrect), and executes error processing (No at Step S144 to Step S150). The case where the controller 200 does not receive the user ID is, for example when the controller 200 receives such a message as an error message from the authentication server 30, and when the controller 200 fails to communicate with the authentication server 30. Moreover, the error processing is processing to transmit an error message to the terminal apparatus 10 that has transmitted the information for authentication.

Furthermore, if, at Step S140, the controller 200 does not receive the access token or the e-mail address; that is, the controller 200 receives the user ID and the password from the terminal apparatus 10, the controller 200 executes processing, using the user ID and the password (No at Step S140). For example, the controller 200 transmits the user ID and the password through the communications unit 290 to the authentication server 30, and receives the authentication result from the authentication server 30. In such a case, if the authentication result indicates that the user is determined by the authentication server 30 as authentic, the controller 200 issues the session ID. Moreover, the controller 200 stores, in the session information storage region 264, the session information in which the issued session ID is associated with the user ID received from the terminal apparatus 10. Then, the controller 200 transmits the issued session ID to the terminal apparatus 10 that has transmitted the user ID and the password. Meanwhile, if the authentication result indicates that the user determined by the authentication sever 30 as inauthentic, the controller 200 executes the error processing.

With reference back to FIG. 12, the controller 200 determines whether the session ID and image data have been received (Step S124). The session ID is associated with the user ID of the user authenticated by the authentication server 30 and the IdP server 40. Hence, in receiving the session ID, the controller 200 can determine that the authenticated user has transmitted the image data. Hence, if, at Step S124, the controller 200 receives the image data not including the session ID, the controller 200 may execute the error processing. Moreover, even if the controller 200 receives the session ID, the controller 200 may execute the error processing when the session information storing the session ID is not stored in the session information storage region 264.

Then, if the controller 200 receives the session ID and the image data, the controller 200 obtains a user ID; that is, identification information associated with the received session ID (Yes at Step S124 to Step S125). For example, the controller 200 reads out, from the session information storage region 264, the session information storing the received session ID, and obtains the user ID stored in the read out session information. Then, the controller 200 transmits, to the authentication server 30, the user ID obtained at Step S125 (Step S126).

Then, the controller 200 receives privilege information from the authentication server 30, and determines whether the user, who is associated with the session ID received at Step S124, is granted a privilege to use the print function (Step S128 to Step S130). For example, if the privilege information, which has been received from the authentication server 30, includes information to grant the user the privilege to use the print function (e.g. information “PRINT”), the controller 200 may determine that the user is granted the privilege to use the print function.

If the user is granted the privilege to use the print function, the controller 200 executes printing (Yes at Step S130 to Step S132). For example, the controller 200 causes the image generator 230 to form, on a recording medium, an image based on the image data received at Step S124. When the printing ends, the controller 200 transmits history information through the communications unit 290 to the authentication server 30 (Step S134). In such a case, the history storage 306 of the authentication server 30 executes processing to store the history information. Note that if, at Step S130, the controller 200 determines that the user is not granted the privilege to use the print function, the processing at Steps S132 and S134 may be omitted (skipped) (No at Step S130).

### 1.3.4. Sequence of Processing on Authentication Server

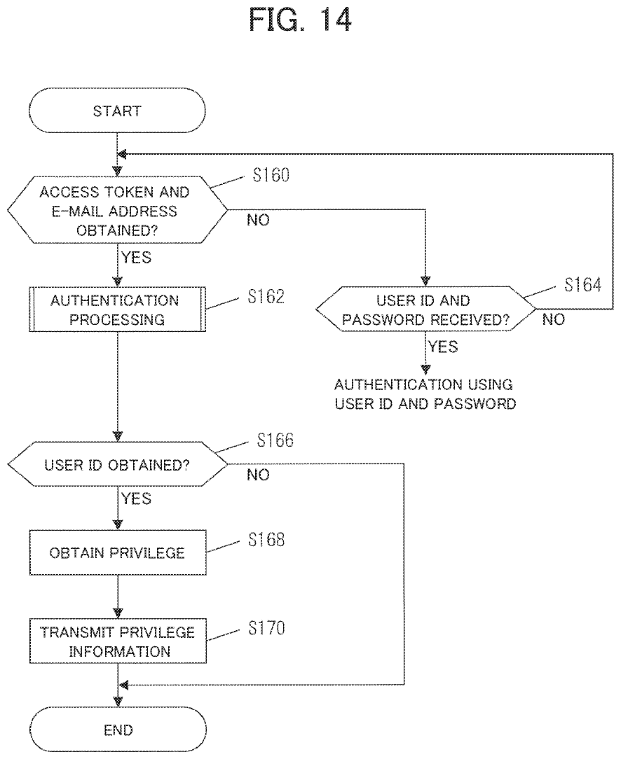

Next, with reference to FIG. 14, processing executed by the authentication server 30 is described. First, the controller 300 determines whether the access token and the issued by the IdP server 40 have been obtained (Step S160). For example, if the controller 300 receives the access token and the e-mail address from the image forming apparatus 20 through the communications unit 390, the controller 300 determines to have received the access token and the e-mail address.

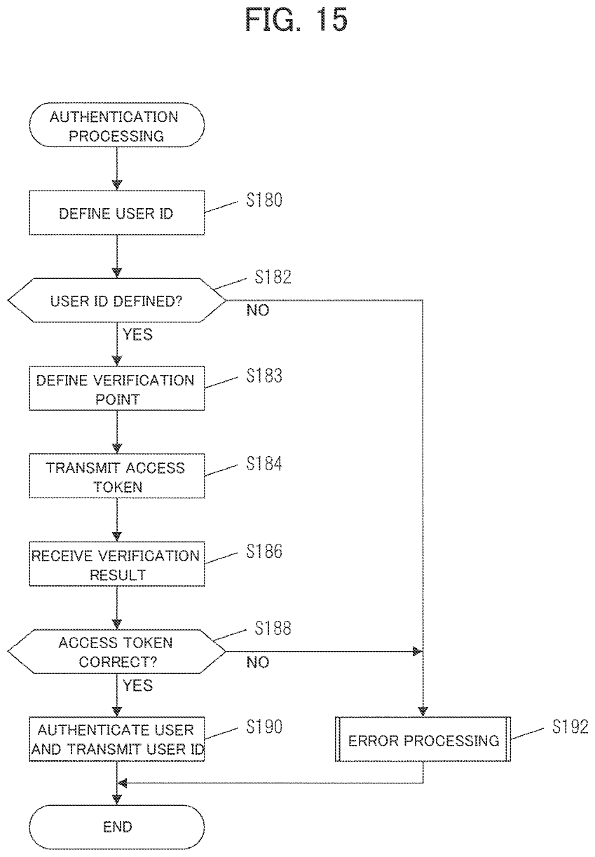

If the controller 300 (the authenticator 302) receives the access token and the e-mail address, the controller 300 (the authenticator 302) executes authentication processing to authenticate the user in accordance with the received information (Yes at Step S160 to Step S162). The authentication processing, is described with reference to FIG. 15.

First, the authenticator 302 defines the user by the e-mail address, and defines the user ID of the user (Step S180). Here, the e-mail address is the second identification information, and the authenticator 302 can identify (define) the user by the e-mail address. Hence, for example, the authenticator 302 obtains, from the user information storage region 362, the user information storing the e-mail address received at Step S160 of FIG. 14. Then, the authenticator 302 reads out the user ID, stored in the obtained user information, to obtain (define) the user ID.

If the authenticator 302 can define the user ID, the authenticator 302 defines a verification point corresponding to the received e-mail address (Yes at Step S182 to Step S183). For example, the authenticator 302 reads out the user information obtained at Step S180 to define the verification point. Moreover, the authenticator 302 transmits an access token to the verification point defined at Step S183 to send the verification point a verification request of the access token (Step S184). For example, the authenticator 302 transmits the access token, received at Step S170, to the verification point stored in the user information obtained at Step S180.

Furthermore, the authenticator 302 receives a verification result of the access token from the verification point through the communications unit 390 (Step S186).

For example, if the verification point is the IdP server 40, the authenticator 302 transmits the access token to the IdP server 40. In such a case, the access token is verified by the verificator 404 of the IdP server 40. Moreover, the authenticator 302 receives, from the IdP server 40, the verification result of the access token.

In accordance with the verification result, the authenticator 302 determines whether the access token received at Step S170 is correct (Step S188). If the access token is correct, the authentication 302 authenticates the user. Then, the authenticator 302 transmits the user ID, defined at Step S180 as an authentication result, through the communications unit 390 to the image forming apparatus 20 that has transmitted the access token and the e-mail address (Yes at Step S188 to Step S190). Nate that, to the image forming apparatus 20, the authenticator 302 may transmit, together with the user ID, information indicating that the user is authenticated correctly.

Executing the above processing, the authenticator 302 authenticates the user in accordance with the e-mail address; that is, the second identification information also serving as the attribute information included in the transmission information to be transmitted from the IdP server 40. and with the access token issued by the IdP server 40. That is, the authenticator 302 authenticates the user if the two conditions below are satisfied:

(1) user information on the user corresponding to the e-mail address is stored; and (2) the access token is correct.

Here, the case where the condition (1) is satisfied is when the user corresponding to the e-mail address is a user managed by the authentication server 30. The e-mail address is also information to be transmitted together with the access token when the user is authenticated by the IdP server 40. Hence, the authenticator 302 can associate information to be transmitted from the IdP server 40 with the user managed by the authentication server 30.

Note that if the above condition is not satisfied, the authenticator 302 executes error processing. Specifically, if the authenticator 302 cannot define the user ID at Step S182, the authenticator 302 executes the error processing (No at Step S182 to Step S192). The case where the user ID cannot be defined is when the user information, storing the e-mail address received at Step S170, cannot be obtained from the user information storage region 362 (when the user information is not stored in the user information storage region 362). Moreover, if the authenticator 302 determines at Step S188 that the access token is not correct, the authenticator 302 executes the error processing (No at Step S188 to Step S192). The error processing is processing in which, for example, the authenticator 302 transmits an error message, as an authentication result of the user authentication, through the communications unit 390 to the image forming apparatus 20 that has transmitted the access token and the e-mail address.

With reference back to FIG. 14, the controller 300 determines whether the user ID has been obtained from the image forming apparatus 20 through the communications unit 390 (Step S166). The user ID is information on the user. For example, if the controller 300 receives the user ID from the image forming apparatus 20 through the communications unit 390, the controller 300 determines to have obtained the user ID.

If the controller 300 (the permitter 304) obtains the user ID, the controller 300 obtains a privilege of the user corresponding to the user ID (Yes at Step S166 to Step S168). For example, the permitter 304 reads out, from the user information storage region 362, the user information storing the user ID obtained at Step S166, and obtains information on the privilege stored in the read-out user information. Then, the controller 300 (the permitter 304) transmits, through the communications unit 390 to the image forming apparatus 20 that has transmitted the user ID, privilege information (Step S170). The privilege information is information indicating the obtained privilege.

Hence, if the permitter 304 obtains the user ID; namely, information on the user, the permitter 304 transmits the privilege information indicating a privilege associated with the user identified with the user ID, and successfully grants the privilege to the user. In particular, in this embodiment, the permitter 304 grants privileges to the user to use functions (e.g. the print function, the copy function, and the scan function) of the image forming apparatus 20. Note that, if, at Step S166, the permitter 304 determines not to have the user ID obtained, the processing at Steps S168 and S170 is omitted (skipped) (No at Step S166).

Note that, if, at Step S160, the controller 300 (the authenticator 302) does not receive the access token or the e-mail address, the controller 300 determines whether the user ID and the password have been received from the image forming apparatus 20 (No at Step S160 to Step S164). if the controller 300 (the authenticator 302) receives the user ID and the password, the controller 300 executes processing to authenticate the user in accordance with the user ID and the password.

For example, if the user information storage region 362 stores user information including the user ID and the password received from the image forming apparatus 20, the authenticator 302 authenticates the user. Meanwhile, if the user information storage region 362 does not store the user information including the user ID and the password received from the image forming apparatus 20, the authenticator 302. does not authenticate the user. Then, the authenticator 302 transmits information indicating whether the user is authenticated; that is, an authentication result, to the image forming apparatus 20 that has transmitted the user ID and the password.

### 1.4 EXAMPLE

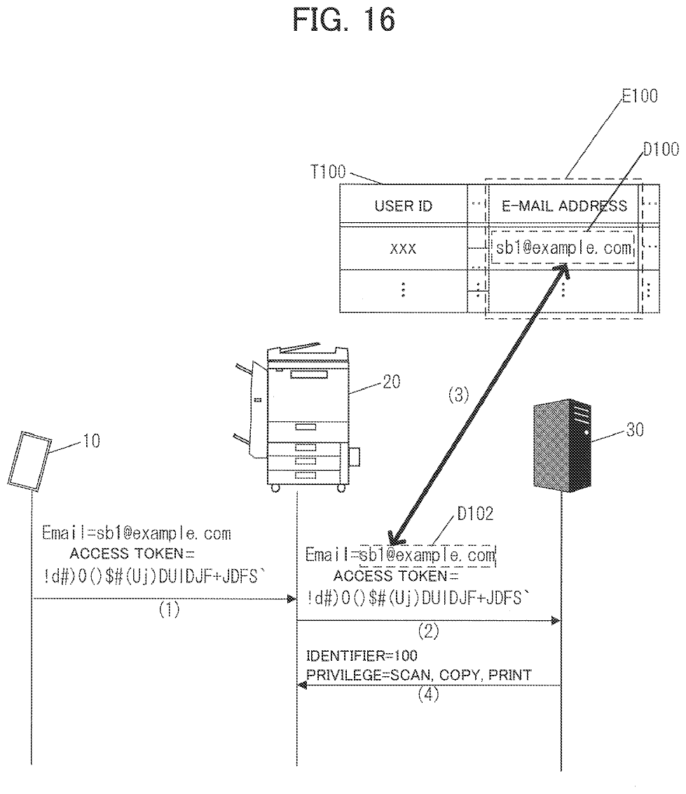

Next, with reference to FIG. 16, an exemplary operation of this embodiment is described. FIG. 16 is a diagram showing that attribute information (an e-mail address) on a user is transmitted by the IdP server 40, and used to associate the user managed by the IdP server 40 with a user managed by the authentication server 30. Note that T100 of FIG. 16 indicates user information managed by (stored in) the authentication server 30.

In this embodiment, the user information to be managed by the authentication server 30 includes an e-mail address E100 to be transmitted, together with an access token, by an IdP server 40 to be described later. In such a case, the system 1 according to this embodiment can use the e-mail address to be transmitted from the IdP server 40, in order to authenticate a user of the image forming apparatus 20.

In this embodiment, the user uses a user authentication service to be provided by the IdP server 40 through the terminal apparatus 10. Here, if the IdP server 40 authenticates the user, the terminal apparatus 10 receives, from the IdP server 40, the e-mail address and the access token as transmission information, Hence, the terminal apparatus 10 transmits the e-mail address and the access token to the image forming apparatus 20 to send an authentication request ((1) in FIG. 16). The image forming apparatus 20 transmits the e-mail address and the access token to the authentication server 30 ((2) in FIG. 16).

If the authentication server 30 stores the user information including the e-mail address received from the image forming apparatus 20, the authentication server 30 can determine that the user corresponding to the e-mail address is a user managed by the authentication server 30. Meanwhile, if the authentication server 30 does not store the user information including the e-mail address received from the image forming apparatus 20, the authentication server 30 can determine that the user corresponding to the e-mail address is not a user managed by the authentication server 30.

For example, as shown by (3) of FIG. 3, there is a case where an e-mail address D100 included in the user information stored in the authentication server 30 matches an e-mail address D102 to be transmitted from the image forming apparatus 20. In such a case, the authentication server 30 can determine that the user corresponding to the e-mail address is a user managed by the authentication server 30. Hence, the authentication server 30 uses information to be transmitted from the IdP server 40 to successfully associate a user managed by the authentication server 30.

Moreover, the authentication server 30 transmits, to the image forming apparatus 20, privilege information indicating a privilege associated with the user managed by the authentication server 30 ((4) of FIG. 16). Hence, the authentication server 30 can grant the privilege to the user. Furthermore, with reference to the privilege information, the image forming apparatus 20 can determine the privilege granted to the user. Note that, together with the privilege information, the authentication server 30 may transmit information on the user (e.g. an identifier) to the image forming apparatus 20.

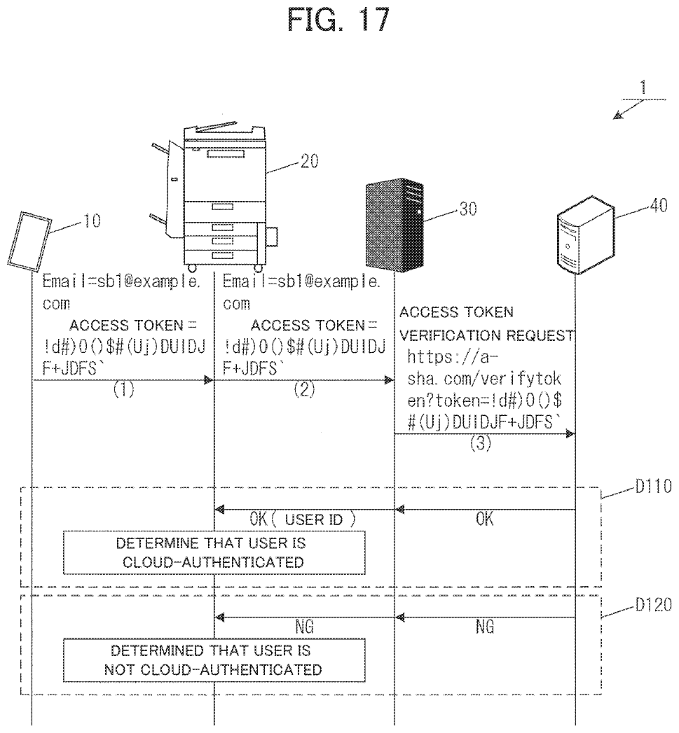

FIG. 17 is a diagram showing verification of the access token. As illustrated in FIG. 17, the authentication server 30 receives, through the image forming apparatus 20, the e-mail address and the access token that the terminal apparatus 10 has received from the IdP server 40 ((1) and (2) of FIG. 17).

Here, the authentication server 30 stores a verification point for each of the users to verify an access token. Hence, the authentication server 30 can set a verification point to verify an access token for each of the accounts of the users who use the image forming apparatus 20, and can switch the set verification points. The authentication server 30 transmits an access token to a verification point to send a verification request of the access token ((3) of FIG. 17). Hence, the authentication server 30 can receive, from the verification point (e.g. the IdP server 40), the verification result of the access token.

If the access token is correct, as illustrated in D110 of FIG. 17, the authentication result, showing that the access token is correct, is transmitted from the IdP server 40 to the authentication server 30. Moreover, the authentication server 30 transmits, to the image forming apparatus 20, the user ID of the user corresponding to the e-mail address transmitted from the terminal apparatus 10 through the image forming apparatus 20. Hence, receiving the user ID from the authentication server 30, the image forming apparatus 20 can determine that the user corresponding to the user ID is authenticated by the IdP server 40 (cloud-authenticated).

Meanwhile, if the access token is not correct, as illustrated in D120 of FIG. 17, the authentication result, showing that the access token is not correct, is transmitted from the IdP server 40 to the authentication server 30. Moreover, the authentication server 30 transmits, to the image forming apparatus 20, information indicating an error, such as an error message. Hence, the image forming apparatus 20 determines that the user operating the terminal apparatus 10 is not a cloud-authorized user, and can execute error processing.

Note that, in this embodiment, the user can use an access token, issued by the IdP server 40 to deal with a Web service and a cloud service in use, to have an authentication for use of the image forming apparatus 20. Hence, when using the image forming apparatus 20, the user can use the user authentication service of the IdP server 40 in common use.

Note that other than the above description, the specifics of the processing may be modified as long as the modification is consistent. For example, the above description presents processing in accordance with the presence or absence of the privilege for the print function. Alternatively the above description may be applied to processing in accordance with the presence or absence of privileges of the copy function, the scan function, and a setting of the image forming apparatus. In such a case, the user can use a function that the permitter permits for use. For example, the user transmits, through the terminal apparatus 10 to the image forming apparatus 20, a session ID and information on processing such as the specifics of the processing and data subjected to the processing. The image forming apparatus 20 obtains a user ID corresponding to the session ID, and executes processing to check whether the user to be identified with the user ID is granted a privilege to carry out predetermined processing. If the user is granted to a privilege to carry out the predetermined processing, the image forming apparatus 20 executes the predetermined processing corresponding to the specifics of the processing transmitted from the terminal apparatus 10 and to the data subjected to the processing. Meanwhile, if the user is not granted the privilege to carry out the predetermined processing, the image forming apparatus 20 does not execute the predetermined processing.

Moreover, in the above description, the determination whether the access token is correct is made, using the access token alone. However, the determination whether the access token is correct may be made with the access token and information on the e-mail address. In such a case, at S1010 of FIG. 9 and at Step S142 of FIG. 13, the authenticator 302 of the authentication server 30 transmits the access token and the e-mail address to the IdP server 40. Furthermore, at S1012 of FIG. 9, if the user information including the access token and the e-mail address received from the authentication server 30 is stored in the user information storage region 462, the verificator 404 of the IdP server 40 determines that the access token is correct.

Moreover, in the above description, the transmission information to be transmitted by the IdP server 40 includes the access token and the attribute information on the user. Here, the access token is security information indicating that the user is authenticated by the IdP server 40, and used to verify that the user is authenticated. However, the security information may be information other than the access token as long as the information can indicate that the user is authenticated, and can verify that the user is authenticated.

Furthermore, in the above description, the identification information (e.g. S1018 of FIG. 9 and S1100 of FIG. 10) to be transmitted and received between the authentication server 30 and the image forming apparatus 20 is the user ID; namely, the first identification information. However, identification information other than the user ID may be transmitted and received. That is, the identification information to be transmitted and received between the authentication server 30 and the image forming apparatus 20 may include the e-mail address; namely, the second identification information, and the identifier; namely, the third identification information.

In addition, in this embodiment, the IdP server verifies the access token. However, an apparatus other than the IdP server may verify the access token. In such a case, the user information managed by the authentication server 30 stores, as information on the verification point, attributes such as the address and the name of an apparatus to verify the access token.

Hence, the image forming apparatus according to this embodiment authenticates the user who uses the image processing device, using the user information transmitted from the IdP server and the access token issued by the IdP server. Moreover, the image forming apparatus according to this embodiment can determine the functions and the like of the image forming apparatus that the verified user is granted a privilege to use. As a result, the image forming apparatus according to this embodiment can obtain the authentication and the privilege of the user, in accordance with the information to be transmitted from the IdP server. Furthermore, when the image forming apparatus is operated with the terminal apparatus, the terminal apparatus does not have to transmit password information through a network to the image forming apparatus (notify the image forming apparatus of password information through a network). In addition, the terminal apparatus does not have to transmit the password information through the network. Hence, leakage of the password through the network can be prevented (i.e. the risk of eavesdropping can be reduced). In addition, the user can use an authentication technique other than the authentication technique using the user ID and the password. Hence, other than user authentication with a conventional authentication server and a one-time password, this embodiment can implement multi-factor authentication using a result of verification by the IdP server.

Moreover, the user of the system according to this embodiment can perform an authentication operation required to use the image forming apparatus, simply using the terminal apparatus. After authorized, the user can directly transmit image data to the image forming apparatus, using the terminal apparatus. Such a feature can eliminate the need of the user visiting a place where the image forming apparatus is installed, and directly operating the image forming apparatus.

### 2. SECOND EMBODIMENT

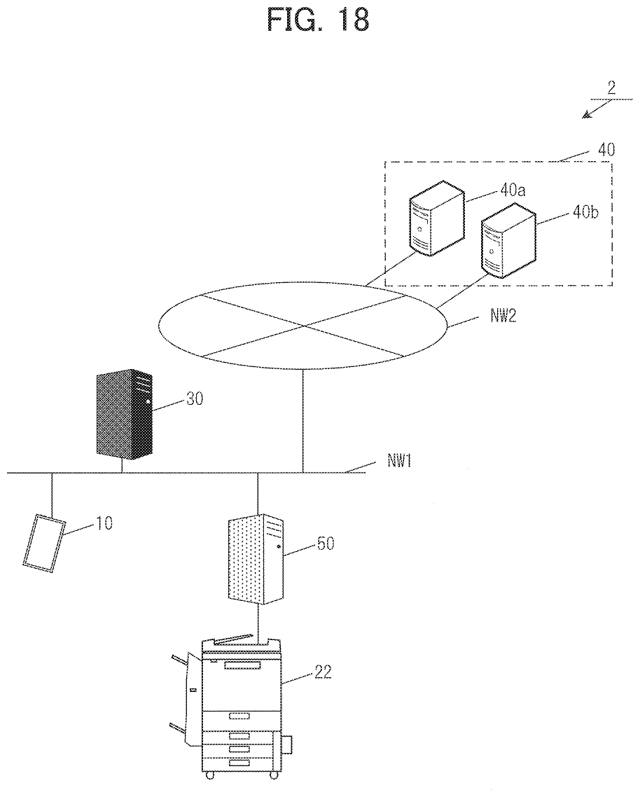

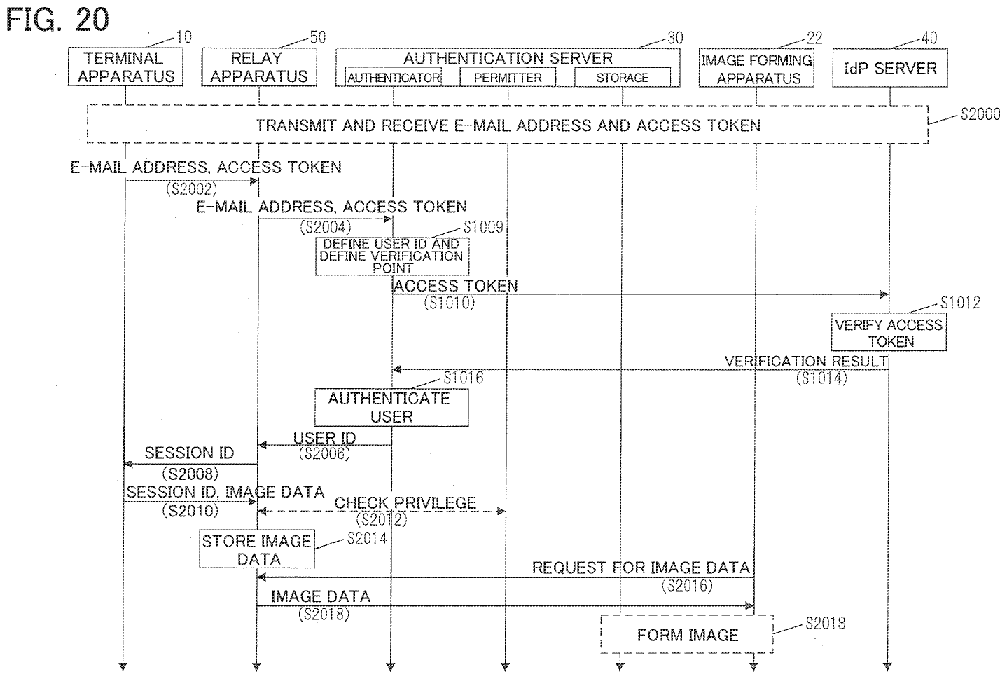

Described next is a second embodiment. The second embodiment is conceived of a case where a terminal apparatus and an image forming apparatus cannot directly communicate with each other. In this embodiment, FIGS. 1 and 9 of the first embodiment are respectively replaced with FIGS. 18 and 20. Note that like reference signs designate identical apparatuses and processing operations, and descriptions of such apparatuses and processing operations may be omitted.

### 2.1 Overall Configuration

With reference to FIG. 18, an overall configuration of a system 2 according to this embodiment is described. As illustrated in FIG. 18, the system 2 is different from the system 1 described in the first embodiment in that a relay apparatus 50 is connected to the network NW1. Moreover, the image forming apparatus 20 is not connected to the network NW1. Meanwhile, an image forming apparatus 22 is connected to the relay apparatus 50.

As illustrated in FIG. 18, the image forming apparatus 22 is not connected to the network NW1 to which the terminal apparatus 10 is connected. Hence, the terminal apparatus 10 and the image forming apparatus 22 cannot directly communicate with each other. Note that even if the terminal apparatus 10 and the image forming apparatus 22 are connected to the network NW1, the terminal apparatus 10 and the image forming apparatus 22 might not be able to directly communicate with each other. Specifically, this is when a communication failure occurs between the terminal apparatus 10 and the image forming apparatus 22, and when direct communications are prohibited between the terminal apparatus 10 and the image forming apparatus 22.

Meanwhile, in this embodiment, the terminal apparatus 10 and the relay apparatus 50 can communicate with each other. Moreover, in this embodiment, the terminal apparatus 50 and the relay apparatus 22 can communicate with each other.

### 2.2 Functional Configuration

### 2.2.1 Relay Apparatus

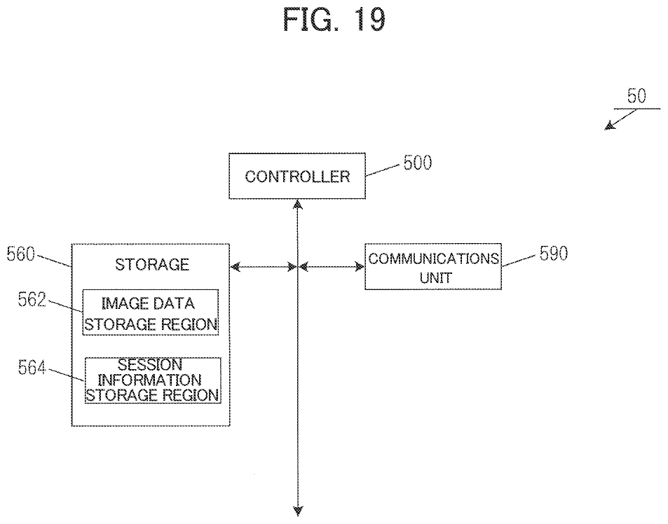

Next, a functional configuration of the relay apparatus 50 according to this embodiment is described. The relay apparatus 50 is an information processing apparatus; that is, a computer such as, for example, a PC and a server. As illustrated in FIG. 19, the relay apparatus 50 according to this embodiment includes: a controller 500; a storage 560; and a communications unit 590.

The controller 500 controls an entirety of the relay apparatus 50. The controller 500 reads and executes various kinds of programs stored in the storage 560 to implement various kinds of functions. The controller 500 includes one or a plurality of arithmetic apparatuses (e.g. a CPU).

The storage 560 stores various kinds of programs and data required for the operation of the relay apparatus 50. The storage 560 is configured of, for example, a storage device including such a semiconductor memory as an SSD, and an HDD. The storage 560 includes, as storage regions, an image data storage region 562 to store image data, and a session information storage region 564 to store session information. Note that the session information to be stored in the session information storage region 564 is information similar to the session information to be stored in the session information storage region 264 described in the first embodiment.

The communications unit 590 communicates with such an external apparatus as the terminal apparatus 10 and the authentication server 30. The communications unit 590 is configured of, for example, a communications apparatus and a communications module such as an NIC to be used on a wired/wireless LAN.

### 2.2.2 Image Forming Apparatus

The image forming apparatus 22 according to this embodiment is different from the image forming apparatus 20 described in the first embodiment in that the storage 260 does not include the session information storage region 264. Note that other features of the image forming apparatus 22 are similar to those of the image forming apparatus 20.

### 2.3 Sequence of Processing on Entire System

With reference to FIG. 20, a sequence of processing on the system 2 according to this embodiment is described. Note that the controller 100 of the terminal apparatus 10 has predetermined functions implemented by the operation application 162.

First, the terminal apparatus 10 and the IdP server 40 execute processing to transmit and receive an e-mail address and an access token. The processing executed at S2000 is similar to the processing from S1000 to S1004 in FIG. 9 according to the first embodiment.

Then, the controller 100 of the terminal apparatus 10 transmits, through the communications unit 190 to the relay apparatus 50, the e-mail address (attribute information on the user) and the access token that are transmission information transmitted from the IdP server 40 (S2002). Hence, the relay apparatus 50 can obtain the transmission information transmitted from the IdP server 40.

The controller 500 of the relay apparatus 50 transmits the access token through the communications unit 590 to the authentication server 30 (S2004). Hence, the authentication server 30 can obtain the e-mail address (the attribute information on the user) and the access token that are the transmission information transmitted from the IdP server 40.

Then, the authentication server 30 and the IdP server 40 execute processing from S1010 to S1016 in FIG. 9 according to the first embodiment. Moreover, through the communications unit 390, the authenticator 302 of the authentication server 30 transmits a user ID; namely, identification information, to the relay apparatus 50 that has transmitted the e-mail address (the attribute information on the user) and the access token (S2006).

Then, the controller 500 of the image forming apparatus 50 issues a session ID. The controller 500 stores, in the session information storage region 564, session information including the issued session ID and the user ID received at S2006. Then, the controller 500 transmits the issued session ID through the communications unit 590 to the terminal apparatus 10 that has transmitted the e-mail address and the access token at S2002 (S2008).

Then, the controller 100 of the terminal apparatus 10 transmits the session ID received at S2008 and image data through the communications unit 190 to the relay apparatus 50 (S2010).

Then, the relay apparatus 50 and the authentication server 30 check a privilege of the user transmitted the image data (S2012). The processing at S2012 is similar to the processing illustrated in FIG. 10 of the first embodiment. The former processing is different from the latter processing in that the apparatus communicating with the authentication server 30 is not the image forming apparatus 20 but the relay apparatus 50. That is, the authentication server 30 obtains the identification information from the relay apparatus 50, and transmits privilege information indicating a privilege associated with the user identified with the identification information.

Then, if the controller 500 of the relay device 50 determines that the user who has transmitted the image data at S2010 is granted a privilege to use the print function, the controller 500 stores, in the image data storage region 562, the image data received at S2010 (S2014). Note that, if the controller 500 determines that the user who has transmitted the image data is not granted the privilege to use the print function, the controller 500 does not store, in the image data storage region 562, the image data received at S2010.

Then, the controller 200 of the image forming apparatus 20 transmits a request for the image data through the communications unit 290 to the relay apparatus 50 (S2016). The processing to transmit the request for the image data is polling processing to be periodically executed at predetermined time intervals.

If the controller 500 of the relay apparatus 50 receives the request for the image data from the image forming apparatus 20, the controller 500 transmits, to the image forming apparatus 20, the image data stored in the image data storage region 562 (S2018). The image forming apparatus 20, receiving the image data, forms an image based on the received image data, and stores history information in the authentication server 30 (S2020). The processing executed at S2020 is similar to the processing from S1026 to S1030 in FIG. 9 according, to the first embodiment.

According to the above processing, if the user using the terminal apparatus 10 is granted the privilege to use the print function, the image data that has transmitted from the terminal apparatus 10 is transmitted through the relay apparatus 50 to the image forming apparatus 20. Meanwhile, if the user using the terminal apparatus 10 is not granted the privilege to use the print function, the image data is neither stored in the image data storage region 562, nor transmitted to the image forming apparatus 20. As a result, if the user is not granted the privilege to use the print function, the image data transmitted to the relay apparatus 50 is not output from the image forming apparatus 20.

According to the system of this embodiment, even if the terminal apparatus and the image forming apparatus cannot directly communicate with each other, the system can implement, through the relay apparatus, processing similar to the processing implemented by the system described in the first embodiment.

### 3. THIRD EMBODIMENT

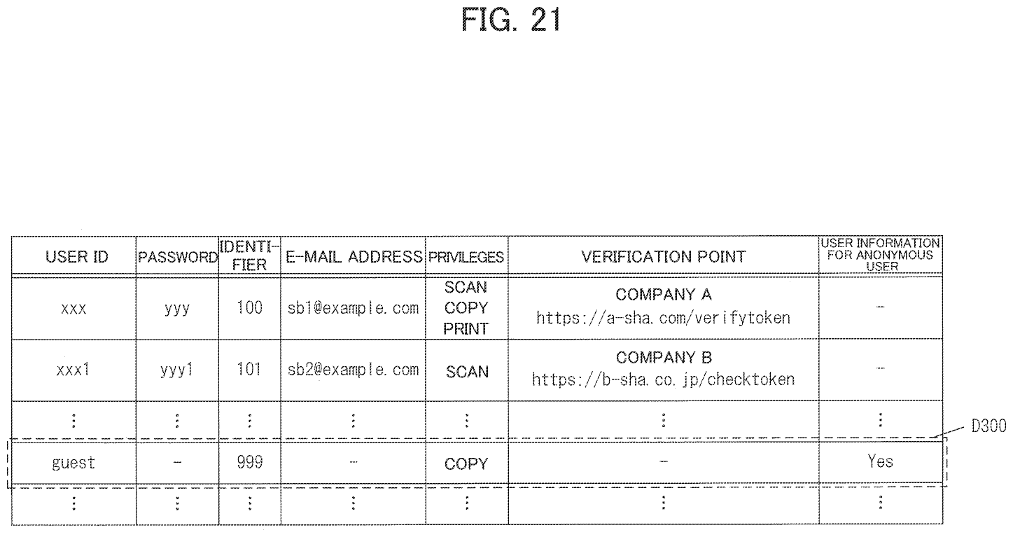

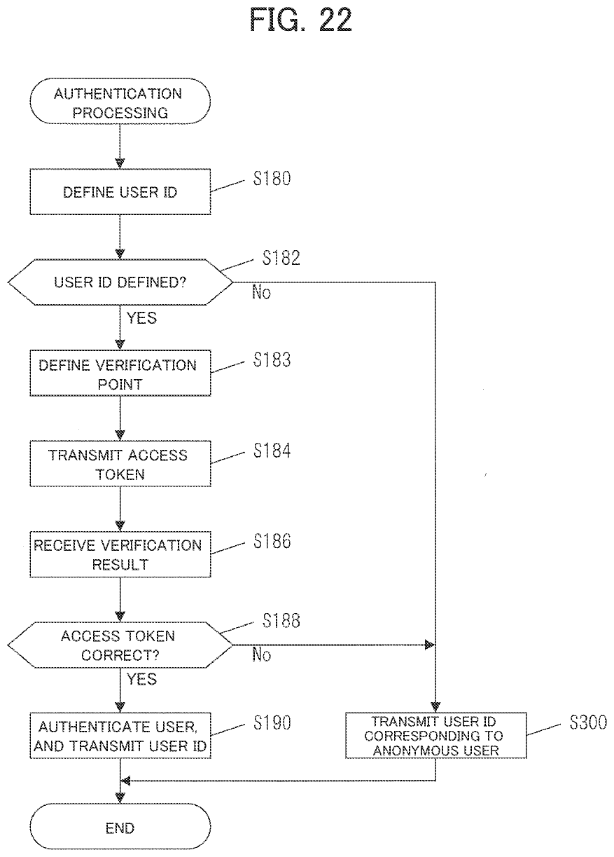

Next, a third embodiment is described. The third embodiment is conceived of a case, if the authentication server cannot identify a user ID corresponding to the e-mail address transmitted from the terminal apparatus, the authentication server handles the user as an anonymous user (a guest user) instead of executing the error processing. In this embodiment, FIGS. 4 and 15 of the first embodiment are respectively replaced with FIGS. 21 and 22. Note that like reference signs designate identical apparatuses and processing operations, and details of such apparatuses and processing operations may be omitted.

With reference to FIG. 21, user information to be stored in the user information storage region 362 according to this embodiment is described. The user information according to this embodiment is different from the user information according to the first embodiment in that the former user information stores information (e.g. “Yes”) indicating whether the information is user information for anonymous user. The anonymous user is a user other than the users managed by the authentication server 30; that is, the anonymous user is referred to as a guest user.

Here, as to the user information for anonymous user included in the user information, the user information storing such information as “Yes” as indicated by D300 of FIG. 21 is user information corresponding to the anonymous user. The user information on the anonymous user stores a user ID (e.g. “guest”) to identify the anonymous user, and a privilege (e.g. “COPY”) corresponding to the anonymous user.

Next, with reference to FIG. 22, a sequence of authentication processing according to this embodiment is described. In this embodiment, if the authenticator 302 cannot authenticate a user, the authenticator 302 determines the user as an anonymous user, and transmits a user ID; that is, identification information corresponding to the anonymous user.

Specifically, the authenticator 302 transmits the user ID corresponding to the anonymous user in the cases below:

(1) a case of storing no user information on the user corresponding to the e-mail address.

The case of storing no user information on the user corresponding to the e-mail address is when, at Step S182, the authenticator 302 cannot identify the user ID (No at Step S182 to Step S300). That is when the user operating the terminal apparatus 10 is not a user managed by the authentication server 30.

(2) a case of an incorrect access token.

The case of an incorrect access token is when, at Step S188, the authenticator 302 receives, from the IdP server 40, a verification result indicating that the access token is incorrect (No at Step S188 to Step S300). The case where the access token is incorrect is, for example, when the user using the terminal apparatus 10 is not authenticated by the IdP server 40, and when the IdP server 40 authenticates the user using the terminal apparatus 10 and, after that, executes log-out processing.

Note that if the authenticator 302 obtains the user ID corresponding to the anonymous user, the authenticator 302 may read out the user information corresponding to the anonymous user, and obtain the user ID stored in the read-out user information.

Hence, in this embodiment, if the authenticator 302 of the authentication server 30 cannot authenticate the user, the authenticator 302 transmits, to the image forming apparatus 20, the user ID corresponding to the anonymous user. The controller 200 of the image forming apparatus 20 determines to have the user ID received at Step S144 of FIG. 13 according to the first embodiment. Hence, the controller 200 executes processing at Steps S146 and S148. Hence, the controller 200 can issue a session ID corresponding to the anonymous user, and transmit the issued session ID to the terminal apparatus 10 that has sent an authentication request. Note that the controller 200 may issue a session ID for each of the terminal apparatuses 10 transmitting an authentication request. Hence, the controller 200 can prepare different session IDs for different anonymous users. Meanwhile, the controller 200 can identify the user ID, corresponding to an anonymous user, from the session ID issued to the anonymous user.

Moreover, if the permitter 304 of the authentication server 30 receives (obtains), from the image forming apparatus 20, the user ID corresponding to the anonymous user, the permitter 304 executes Steps S168 and S170 of FIG. 14. Hence, the permitter 304 obtains a privilege corresponding to the anonymous user, and transmits the privilege information to the image forming apparatus 20.

Thanks to such processing, even if a user is not authenticated by the authentication server 30 (e.g. a user is not managed by the authentication server 30), the user is handled as an anonymous user and granted a predetermined privilege.

Note that the authentication server 30 may limit privileges to be granted to anonymous users. For example, as a privilege of user information corresponding to an anonymous user, the authentication server 30 stores information indicating limitations of available functions and setting specifics, compared with the user information corresponding a non-anonymous user, Hence, the anonymous user is granted with limited privileges.

Hence, in this embodiment, even if a user is not authenticated by the authentication server 30, the user can use a predetermined function provided to the image forming apparatus.

### 4. FOURTH EMBODIMENT

Next, a fourth embodiment is described. In the fourth embodiment, the image forming apparatus functions as an authentication server. This embodiment can be applied to any of the first to third embodiments.

For example, in either the image forming apparatus 20 or the image forming apparatus 22, the controller 200 may function as an authenticator 302. Here, the image forming apparatus 20 is provided with a storage region to store user information including at least a user name, a password, an e-mail address of a user identified by the user name, and a verification point; that is, a request receiver of a verification request for verification of whether the access token is correct. Then, the controller 200 executes the authentication processing shown in FIG. 15 of the first embodiment. In such a case, the authenticator 302 is included in the image forming apparatus 20, thereby omitting processing (e.g. S1018 of FIG. 9) of the authenticator 302 to transmit, to the image forming apparatus 20, identification information on the user who uses the image forming apparatus.

Moreover, in either the image forming apparatus 20 or the image forming apparatus 22, the controller 200 may function as the permitter 304. In such a case, the image forming apparatus 20 stores, in the storage 260, information on a permitted function for each of the users. Then, the controller 200 executes the processing at Step S168 of FIG. 14. In such a case, the permitter 304 is included in the image forming apparatus 20, thereby omitting the communications processing (e.g. S1100 and S1014 of FIG. 10) between the permitter 304 and the image forming apparatus 20.

Moreover, in either the image forming apparatus 20 or the image forming apparatus 22, the controller 200 may implement the functions of the history storage 306. In such a case, the image forming apparatus 20 provides the storage 260 with a storage region for the history information. Moreover, in such a case, the history storage 306 is included in the image forming apparatus 20, thereby omitting processing (S1028 of FIG. 9) in which the history storage 306 receives the user ID and the history information from the image forming apparatus 20.

Hence, either the image forming apparatus 20 or the image forming apparatus 22 may include some or all of the functions provided to the authentication server 30. Such a feature reduces communications processing between either the image forming apparatus 20 or the image forming apparatus 22 and the authentication server 30, and diversifies load on the authentication server 30. Moreover, when either the image forming apparatus 20 or the image forming apparatus 22 is provided entirely with the functions of the authentication server 30, the authentication server 30 may be omitted in either the system 1 or the system 2.

Hence, in this embodiment, even if the image forming apparatus is provided with some or all of the functions of the authentication server, the image forming apparatus can implement the same processing as the processing on the systems described in the first to third embodiments.

Note that, if security information such as an access token can be verified by an apparatus other than the IdP server 40, the function of the verificator 404 of the IdP server 40 may be implemented by any of the image forming apparatus 20, the image forming apparatus 22, and the authentication server 30.

### 5. MODIFICATIONS

An aspect of the present invention shall not be limited to the above embodiments, and may be modified in various manners. That is, an embodiment may include technical means appropriately combined together unless otherwise departing from the subject-matter of the present invention. Such an embodiment shall be included in the technical scope of the present invention.

For example, an obtainer that obtains a mail address of, and security information on, the user may be implemented in a form of an obtainment apparatus. The verificator that verifies the security information at the verification point identified with the e-mail address may be implemented in a form of a verification apparatus. The authenticator that authenticates the user if the security information is not able to be verified correctly may be implemented in a form of an authentication apparatus. In the above embodiment, for example, the obtainment apparatus is the image forming apparatus 20, the verification apparatus is the IdP server 40, and the authentication apparatus is the authentication server 30.

Moreover, when the user is authenticated, the transmitter transmits, to the terminal apparatus, the communications identification information to be used for communications with the image forming apparatus. Such a transmitter may be implemented in a form of a transmission apparatus. Furthermore, when a user corresponding to the communications identification information is granted a privilege to execute the processing, a processing executor to execute the processing may be implemented in a form of a processing execution apparatus if the processing executor receives the communications identification information and information on processing. In the above embodiment, for example, the transmission apparatus and the processing execution apparatus are the image forming apparatus 20.

In addition, the above embodiments include features described separately for the sake of description. As a matter of course, such features may be implemented in combination within a technically available scope. For example, the second embodiment and the third embodiment may be combined to receive privilege information corresponding to an anonymous user.

Moreover, a program operating on each of the apparatuses in the embodiments is a program (a program to run a computer) to control the CPU and the like to implement the functions of the above embodiments. Then, information handled on these apparatuses is temporarily accumulated in a temporal storage device (e.g. a RAM) when the information is processed. After that, the information is stored in storage devices such as various kinds of read only memories (ROMs) and HDDs. As necessary, the information is read out, modified, and written by the CPU.

Here, a recording medium to store the program may be any of such devices as: a semiconductor medium (e.g. a ROM and a non-volatile memory card); an optical recording medium and a magneto-optical medium (e.g. a digital versatile disc (DVD), a magneto-optical disc (MO), a mini disc (MD), a compact disc (CD), and a Blu-ray® disk (BD)); and a magnetic recording medium (e.g. a magnetic tape and a flexible disc). Moreover, the functions of the above embodiments are implemented not only by running a loaded program. The functions in an aspect of the present invention may also be implemented, in accordance with an instruction of the program, by processing on an operating system, or on another application program cooperating with the program.

Furthermore, when the program is distributed to the market, the program can be stored in a portable storage medium for distribution, and transferred to a server computer connected through a network such as the Internet. In such a case, as a matter of course, a storage device of the server computer is included in an aspect of the present invention.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An authentication system in which an image forming apparatus authenticates a user, the authentication system comprising:
an obtainer that obtains, from a terminal apparatus, a mail address of, and security information on, the user;
a verificator that verifies the security information at a verification point identified with the mail address; and
an authenticator that authenticates the user if the security information is able to be verified correctly.

2. The authentication system according to claim 1, further comprising:
a transmitter that transmits, to the terminal apparatus, communications identification information to be used for communications with the image forming apparatus, when the user is authenticated by the authenticator; and
a processing executor that executes processing when the user corresponding to the communications identification information is granted a privilege to execute the processing if the processing executor receives the communications identification information and information on the processing.

3. The authentication system according to claim 2,
wherein, if the information on the processing is image data and the user is granted a privilege to print, the processing executor executes the processing to print out the image data.

4. The authentication system according to claim 1,
wherein, if the security information is not able to be verified correctly, the authenticator handles the user as an anonymous user.

5. An information processing apparatus, comprising:
an obtainer that obtains a mail address of, and security information on, a user;
a security information transmitter that transmits the security information to a server apparatus at a verification point corresponding to the mail address;
a result receiver that receives a verification result from the server apparatus at the verification point; and
a verification result transmitter that authenticates the user if the verification result is correct, and transmits an authentication result to an image forming apparatus.

6. An image forming apparatus, comprising:
an obtainer that obtains, from a terminal apparatus, a mail address of, and security information on, a user;
a transmitter that transmits the mail address and the security information to a first server apparatus at an authentication point;
a receiver that receives an authentication result of the user, in accordance with a result of verifying the security information by a second server at a verification point at which the first server apparatus is identified with the mail address; and
an authenticator that authenticates the user if the authentication is correct.
